(19) United States
(12) Patent Application Publication
(10) Pub. No.: US 2026/0315992 A1
(43) Pub. Date: Oct. 15, 2026

(54) TOTAL RECYCLE PROCESS OF CARBONACEOUS COMPONENTS IN COAL GAS BASED ON INTEGRATION OF CARBON DIOXIDE ABSORPTION AND ELECTROCATALYSIS

(71) Applicant: Institute of Process Engineering, Chinese Academy of Sciences, Beijing (CN)

(72) Inventors: Tingyu ZHU, Beijing (CN); Wenqing XU, Beijing (CN); Yang YANG, Beijing (CN); Shaona WANG, Beijing (CN); Zanbu GENG, Beijing (CN)

(21) Appl. No.: 19/463,994

(22) Filed: Jan. 29, 2026

Related U.S. Application Data
(63) Continuation of application No. PCT/CN2025/072652, filed on Jan. 16, 2025.

(30) Foreign Application Priority Data
Sep. 28, 2024 (CN) 202411364019.4

(51) Int. Cl. B01D 53/14; B01D 53/18; C25B 1/23; C25B 11/067; C25B 11/075; C25B 15/08

(52) U.S. Cl. CPC B01D 53/1425; B01D 53/1475; B01D 53/1493; B01D 53/18; C25B 1/23; C25B 11/067; C25B 11/075; C25B 15/081; B01D 2252/20421; B01D 2252/20426; B01D 2257/504

(57) ABSTRACT

A total recycle process of the carbonaceous components in the coal gas based on the integration of the CO₂ absorption and the electrocatalysis is provided. The disclosure captures CO₂ from coal gas using a solution with a primary amine and/or a secondary amine, performs electrocatalytic reduction on the absorption solution to prepare carbon monoxide/hydrogen (CO/H₂) reducing gas, and regenerates the absorption solution during the electrocatalytic reduction process. An improved electrolysis process is used to accelerate the production of CO/H₂ reducing gas, which is mixed with decarbonized coal gas and returned to the smelting process for recycling.

### CROSS-REFERENCE TO RELATED APPLICATIONS

This application is a continuation of International Patent Application No. PCT/CN2025/072652, filed on Jan. 16, 2025, and claims priority of Chinese Patent Application No. 202411364019.4, filed on Sep. 28, 2024. The contents of International Patent Application No. PCT/CN2025/072652 and Chinese Patent Application No. 202411364019.4 are hereby incorporated by reference.

### TECHNICAL FIELD

The present disclosure belongs to the technical field of carbon dioxide (CO₂) capture and utilization from coal gas, and particularly relates a total recycle process of carbonaceous components in coal gas based on integration of CO₂ absorption and electrocatalysis.

### BACKGROUND

With the wide use of fossil fuels and the increase in industrial activities, global carbon dioxide (CO₂) emissions have been increasing year by year. In order to mitigate the negative impacts of climate change, carbon capture and utilization (CCU) technology is considered a solution with industrial application potential. Among various CCU technologies, chemical absorption has attracted much attention due to its high selectivity and wide application range, and has become one of the mainstream technologies for post-combustion CO₂ capture. However, chemical absorption requires processes such as regeneration, capture, and compression, the cumbersome steps result in high energy consumption. Therefore, optimizing the conversion pathway of CO₂ has become a key factor promoting the development of this technology, which requires more attention and investment in technological research and development.

CN110305704A discloses a system and its method for CO₂ capture and utilization coupled with new energy to achieve low energy consumption. The disclosure combines CO₂ capture and utilization using a solid adsorbent, and the method uses a calcium-based absorbent as a reaction catalyst to absorb CO₂ followed by CO₂ methanation. However, this scheme has low and unstable absorption capacity, making it difficult to apply to the treatment of blast furnace coal gas.

CN112981438A discloses a CO₂ electrolysis system for syngas production. The method uses an alkaline solution as the electrolyte, optionally an alkali metal bicarbonate (MHCO₃) or carbonate (M₂CO₂) electrolyte, to produce syngas by changing reaction conditions. The method only includes the CO₂ utilization process and requires continuous introduction of pure CO₂ gas for electrolysis, which is separated from CO₂ capture, resulting in high energy consumption and high cost.

The coal gas generated during the iron and steel smelting process includes 6 percent (%) to 22% CO₂. If the total recycling of carbonaceous components in coal gas may be realized, this measure will undoubtedly help reduce carbon emissions. However, the CO₂ capture methods disclosed in the existing technologies limit their application in the total recycling of carbonaceous components in coal gas. There is no relevant research in the field on how to simply and efficiently remove CO₂ from coal gas and realize the total recycling of carbonaceous components in coal gas.

### SUMMARY

An objective of the disclosure is to provide a total recycle process of carbonaceous components in coal gas based on integration of carbon dioxide (CO₂) absorption and electrocatalysis. The disclosure captures CO₂using a primary amine solution and/or a secondary amine solution to reduce regeneration energy consumption, uses a capture solution as an electrolyte for electrolysis, and combines CO₂ capture and absorption, i.e., integration of CO₂capture and utilization. In the blast furnace reaction, the coal gas is directly captured by organic amines and then subjected to in-situ electrolysis. An improved electrolysis process is used to accelerate mixing of carbon monoxide/hydrogen (CO/H₂) reducing gas and decarburized coal gas, and then returned to the smelting process for recycling. Thus, the reduction performance of the recycled coal gas is improved, replacing coke as a reducing agent, reducing coke usage and carbon emissions, and fully realizing the total recycling of carbonaceous components in coal gas.

In order to achieve the above objective, the present disclosure provides following technical schemes:
a total recycle process of carbonaceous components in coal gas based on integration of carbon dioxide (CO₂) absorption and electrocatalysis, including following steps:
passing coal gas into an absorption tower including an absorption solution with a primary amine and/or a secondary amine for decarbonization; pumping decarbonized absorption solution (i.e. CO₂-rich solution) into an electrolytic cell with a cathode loaded with an electrolytic catalyst; generating CO/H₂ reducing gas and completing regeneration through electrolysis; returning an regenerated absorption solution (i.e. CO₂-lean solution) to the absorption tower for reuse; and co-returning generated CO/H₂ reducing gas and decarbonized coal gas to smelting process for continued use; and
the electrolytic catalyst includes an active component and a carrier, where the active component is one or more of indium (In), gold (Au), and silver (Ag); and the carrier is one or more of zirconium dioxide (ZrO₂), titanium dioxide (TiO₂), and tungsten trioxide (WO₃);

In, Au, and Ag are noble metals inclined to generate CO.

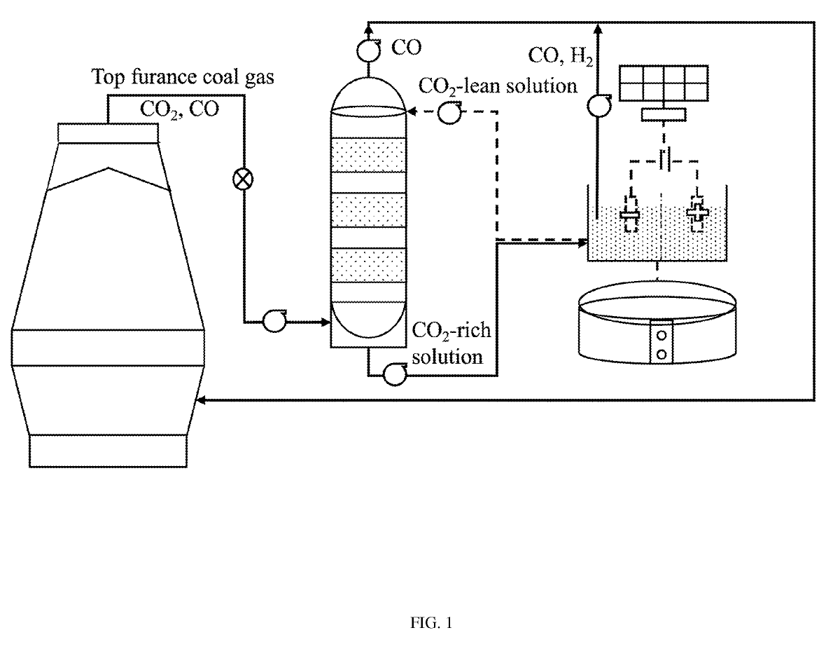

The flow chart of the total recycle process of carbonaceous components in coal gas based on integration of CO₂ absorption and electrocatalysis is shown in FIG. 1.

Although methods for absorbing CO₂ using organic amines and electrolyzing to produce CO/H₂ reducing gas exist in the prior art, the electrocatalysts used in the electrolysis process are noble metals, and the electrolysis efficiency is slow. The slow electrolysis efficiency makes it difficult to timely treat the CO₂absorption solution, hindering the application of absorbing CO₂ by organic amines and electrolyzing to produce CO/H₂ reducing gas in the total recycling of carbonaceous components in coal gas. By improving the electrocatalyst, the present disclosure not only reduces the cost of the electrocatalyst but also greatly accelerates the electrolysis efficiency of the CO₂ absorption solution, enabling the recycling of the CO₂ absorption solution. The absorption solution with primary amine and/or secondary amine is used to absorb CO₂, and then a specific electrocatalyst is used to catalyze the desorption of CO₂ from carbamate, accelerating the absorption and conversion of CO₂, thereby increasing the CO/H₂ ratio, improving the reduction performance of the recycled coal gas, reducing coke consumption, reducing carbon emissions, and realizing the total recycling of carbonaceous components in coal gas.

Optionally, the coal gas includes blast furnace coal gas or shaft furnace coal gas.

Optionally, the primary amine includes a monoethanolamine (MEA) and a 2-amino-2-methyl-1-propanol (AMP); and the secondary amine includes a diethanolamine (EDA).

Optionally, a concentration of the primary amine and/or the secondary amine in the absorption solution with the primary amine and/or the secondary amine is 1 mole/liter (mol/L) to 5 mol/L.

Optionally, a mass fraction of the active component in the electrolytic catalyst is 20 percent (%) to 80%.

Optionally, a temperature during the electrolysis is 10 degrees Celsius (°C) to 60°C, and an applied voltage is 0 volt (V) to -2 V versus (vs.) reversible hydrogen electrode (RHE).

Optionally, the CO/H₂ reducing gas is discharged above the cathode, mixed with the decarbonized coal gas, and returned to the smelting process for recycling.

Under normal conditions, the decarbonized coal gas contains CO of 30 volume percent (vol.%) to 40 vol.% and H₂ of 3 vol.% to 5 vol.%. After accelerating the production of CO/H₂reducing gas by improving the electrolysis process, the recycled coal gas contains CO of 35 vol.% to 45 and H₂ of 13 vol.% to 17 vol.%, i.e., the volume ratio of CO/H₂ in the recycled gas should be 2.3 to 3.4. Thus, the reduction performance of the recycled coal gas is improved, which may reduce coke consumption by 10% to 30%, carbon emissions by 50% to 95%, and capture energy consumption by 100 kilojoule (kJ)/mol to 196 kJ/mol.

The beneficial technical effects of the present disclosure are as follows.

The present disclosure absorbs CO₂ in coal gas using an absorption solution containing primary amine and/or secondary amine to generate carbamate and protonated amine. In the cathode of the electrolytic cell, the carbon-nitrogen (C-N) bond of carbamate is broken through an electrocatalytic reaction, and the protonated amine absorbs protons to complete the organic amine regeneration process, which is returned to the absorption tower for reuse. The electrolysis product, CO/H₂ reducing gas, is a combustible gas that may be reused as an energy source for smelting, improving the reducibility of the recycled coal gas, thereby reducing the use of coke and the cost of blast furnace smelting.

The total recycle process of carbonaceous components in coal gas based on integration of CO₂absorption and electrocatalysis provided by the present disclosure may not only realize the total recycling of carbonaceous components in coal gas and reduce carbon emissions during the smelting process but also has no high-energy-consumption steps. The process for total recycling of carbonaceous components in coal gas provided by the present disclosure saves energy and reduces emissions, and has great popularization and application value.

### BRIEF DESCRIPTION OF THE DRAWING

The FIG. 1 is a flow chart of the total recycle process of carbonaceous components in coal gas based on integration of carbon dioxide (CO₂) absorption and electrocatalysis of the present disclosure.

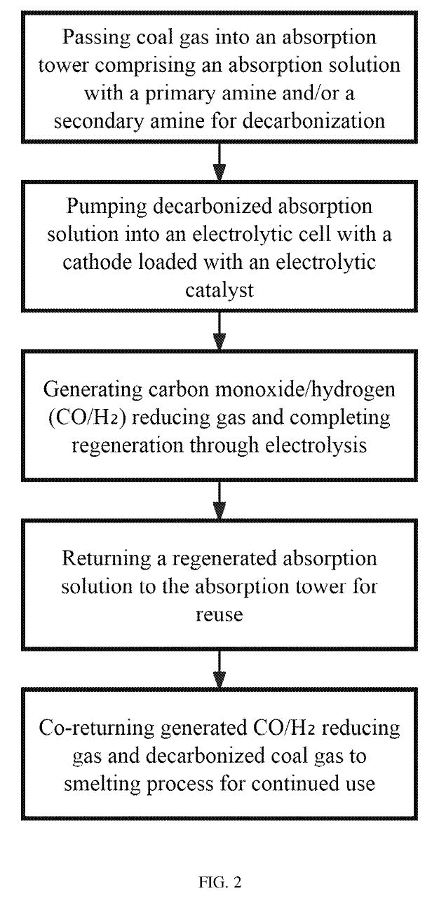

The FIG. 2 is a schematic diagram of the steps for the total recycle process of carbonaceous components in coal gas based on integration of CO₂ absorption and electrocatalysis of the present disclosure.

### DETAILED DESCRIPTION OFTHE EMBODIMENTS

Various exemplary embodiments of the present disclosure are described in detail below. The detailed description should not be construed as a limitation of the present disclosure but as a more detailed description of certain aspects, features, and implementations of the present disclosure. It may be understood that the terms used in the present disclosure are only for describing specific embodiments and are not intended to limit the present disclosure.

In addition, for the numerical ranges in the present disclosure, it may be understood that each intermediate value between the upper limit and the lower limit of the range is also specifically disclosed. Each smaller range between any stated value or intermediate value in the stated range and any other stated value or intermediate value in the stated range is also included in the present disclosure. The upper and lower limits of these smaller ranges may be independently included in or excluded from the range.

Unless otherwise specified, all technical and scientific terms used herein have the same meaning as commonly understood by those of ordinary skill in the field to which the present disclosure belongs. Although the present disclosure only describes preferred methods and materials, any methods and materials similar or equivalent to those described herein may be used in the implementation or testing of the present disclosure.

The terms “comprise”, “include”, “have”, “contain”, etc., used herein are open-ended terms, meaning including but not limited to.

The silver nanoparticles (Ag NPs) in Comparative embodiment 1 of the present disclosure are self-made products, and the preparation method is as follows.

Preparing Ag NPs: 20 milliliters (mL) of silver nitrate (AgNO₃) with a concentration of 20 millimoles/liter (mmol·L⁻¹) is prepared, stirred uniformly, 20 mL of sodium citrate solution with a concentration of 141.6 mmol·L⁻¹ isquickly added, stirred for 10 minutes (min), 25 mL of sodium borohydride solution with a concentration of 30 mmol·L⁻¹ isadded to reduce silver ion (I) (Ag⁺) after stabilization, stirred quickly for 2 hours (h), filtered and washed, and dried in vacuum at 60 degrees Celsius (°C) for 6 h for later use.

The electrocatalysts in Embodiments 1 to 5 and Comparative embodiment 2 of the present disclosure are self-made products, and the preparation method is as follows.

First, a metal oxide with a concentration of 0.1 mmol·L⁻¹ isdissolved in 20 mL of water, add 0.20 mmol·L⁻¹ noble metal nitrate, stirred quickly and uniformly, a sodium citrate solution with a concentration of 20 mL of 141.6 mmol·L⁻¹ is added, stirred for 10 min, the sodium borohydride solution with a concentration of 25 mL of 30 mmol·L⁻¹ is added to reduce the noble metal ions after stabilization, stirred for 2 h, filtered and washed, and dried in vacuum at 60°C for 6 h for later use.

Taking blast furnace smelting as an embodiment (as shown in FIGS. 1 and 2):

First, blast furnace coal gas is passed into an absorption solution containing primary amine and/or secondary amine (concentration of 1 mole (mol) to 5 mol) at a flow rate of 30 L/min to make it absorb saturated, where the CO₂ loading capacity is 0.5 mol/liter (L) to 2.5 mol/L. The saturated absorption solution is pumped into an electrolytic cell for electrolysis, the electrolyzed lean solution is recycled back to the absorption tower for reuse, and the carbon monoxide/hydrogen (CO/H₂) reducing gas generated by electrolysis together and the decarbonized blast furnace coal gas (the decarbonized blast furnace coal gas contains CO of 30 volume percent (vol.%) CO and H₂ of 4 vol.%) are used as recycled coal gas, and returned to the blast furnace for use.

Preparation of the electrolytic cell: the electrolytic cell uses a traditional H-type reaction cell, the cathode uses a glassy carbon electrode coated with a catalyst as the working electrode, the anode uses a platinum sheet electrode as the counter electrode, the reference electrode is a silver/silver chloride (Ag/AgCl) electrode, and the proton exchange membrane is N117, where the preparation process of the working electrode is as follows: first, the prepared electrocatalyst is taken to ultrasonically disperse in a mixed dispersion of deionized water, isopropanol, and 5 weight percent (wt.%) Nafion with a volume ratio of 1:1:0.01, performed ultrasonic treatment for 30 min, then a pipette is used to drop electrocatalyst after ultrasonic treatment on a bottom of a glassy carbon electrode (diameter 10 millimeters (mm)), the electrocatalyst after ultrasonic treatment is spin-coated and dried to load the electrocatalyst on the bottom of the glassy carbon electrode, and the loading capacity of the electrocatalyst is 1 milligram/square centimeter (mg/cm²).

### Embodiment 1

Gold (Au) of 60 wt.%-tungsten trioxide (WO₃) of 40 wt.% is used as the electrocatalyst, 4M (molarity) AMP(2-Amino-2-methyl-1-propanol) is the absorption solution, the electrolysis temperature is 50°C, and the applied voltage is -1 volt versus reversible hydrogen electrode (V vs. RHE). The recycled coal gas includes CO with a concentration of 45 vol.% and H₂ with a concentration of 15 vol.%, and the volume ratio of CO/H₂ is 3. Compared with only using the decarbonized blast furnace coal gas returned to the blast furnace, it may reduce coke consumption by 30%, carbon emissions by 95%, and energy consumption by 196 kilojoule (kJ)/mol.

### Embodiment 2

Indium (In) of 20 wt.%-zirconium dioxide (ZrO₂) of 80 wt.% is used as the electrocatalyst, 4M MEA is the absorption solution, the electrolysis temperature is 10°C, and the applied voltage is -1 V vs. RHE. The recycled coal gas includes CO with a concentration of 41 vol.% and H₂with a concentration 13 vol.%, and the volume ratio of CO/H₂ is 3.1. Compared with only using the decarbonized blast furnace coal gas returned to the blast furnace, it may reduce coke consumption by 10%, carbon emissions by 50%, and energy consumption by 100 kJ/mol.

### Embodiment 3

Ag of 40 wt.%-titanium dioxide (TiO₂) of 60 wt.% is used as the electrocatalyst, 4M AMP is the absorption solution, the electrolysis temperature is 40°C, and the applied voltage is -1.5 V vs. RHE. The recycled coal gas includes CO with a concentration of 42 vol.% and H₂ with a concentration of 17 vol.%, and the volume ratio of CO/H₂ is 2.4. Compared with only using the decarbonized blast furnace coal gas returned to the blast furnace, it may reduce coke consumption by 15%, carbon emissions by 40%, and energy consumption by 120 kJ/mol.

### Embodiment 4

In of 80 wt.%-WO₃ of 20 wt.% is used as the electrocatalyst, 2M MEA is the absorption solution, the electrolysis temperature is 60°C, and the applied voltage is -1 V vs. RHE. The recycled coal gas includes CO with a concentration of 43 vol.% and H₂ with a concentration of 14 vol.%, and the volume ratio of CO/H₂ is 3. Compared with only using the decarbonized blast furnace coal gas returned to the blast furnace, it may reduce coke consumption by 20%, carbon emissions by 60%, and energy consumption by 140 kJ/mol.

### Embodiment 5

In of 60 wt.%-WO₃ of 40 wt.% is used as the electrocatalyst, 2M EDA is the absorption solution, the electrolysis temperature is 40°C, and the applied voltage is -1 V vs. RHE. The recycled coal gas includes CO with a concentration of 44 vol.% and H₂ with a concentration of 15 vol.%, and the volume ratio of CO/H₂ is 2.9. Compared with only using the decarbonized blast furnace coal gas returned to the blast furnace, it may reduce coke consumption by 27%, carbon emissions by 88%, and energy consumption by 170 kJ/mol.

### Comparative embodiment 1

Compared with Embodiment 3, the only difference is that the catalyst loaded on the cathode is replaced with an equal mass of Ag NPs. The recycled coal gas includes CO with a concentration of 32 vol.% and H₂ with a concentration of 8 vol.%, and the volume ratio of CO/H₂ is 4. Compared with only using the decarbonized blast furnace coal gas returned to the blast furnace, it may reduce coke consumption by 6%, carbon emissions by 30%, and energy consumption by 60 kJ/mol.

### Comparative embodiment 2

Compared with Embodiment 1, the only difference is that the catalyst loaded on the cathode is replaced with an equal mass of Au of 10 wt.%- WO₃ of 90 wt.%. The recycled coal gas includes CO with a concentration of 27 vol.% and H₂ with a concentration of 12 vol.%, and the volume ratio of CO/H₂ is 2.2. Compared with only using the decarbonized blast furnace coal gas returned to the blast furnace, it may reduce coke consumption by 5%, carbon emissions by 20%, and energy consumption by 30 kJ/mol.

The above-described embodiments are only for describing the preferred modes of the present disclosure, and are not intended to limit the scope of the present disclosure. Without departing from the design spirit of the present disclosure, various modifications and improvements made by those of ordinary skill in the art to the technical solution of the present disclosure shall fall within the protection scope defined by the claims of the present disclosure.

What is claimed is:

1. A total recycle process of carbonaceous components in coal gas based on integration of carbon dioxide (CO₂) absorption and electrocatalysis, comprising following steps:
passing the coal gas into an absorption tower comprising an absorption solution with a primary amine and/or a secondary amine for decarbonization;
pumping decarbonized absorption solution into an electrolytic cell with a cathode loaded with an electrolytic catalyst;
generating carbon monoxide/hydrogen (CO/H₂) reducing gas and completing regeneration through electrolysis;
returning a regenerated absorption solution to the absorption tower for reuse; and
co-returning generated CO/H₂ reducing gas and decarbonized coal gas to smelting process for continued use;
wherein the electrolytic catalyst comprises an active component and a carrier, wherein the active component is one or more of indium (In), gold (Au), and silver (Ag); and the carrier is one or more of zirconium dioxide (ZrO₂), titanium dioxide (TiO₂), and tungsten trioxide (WO₃);
a mass fraction of the active component in the electrolytic catalyst is 20 percent (%) to 80%; and
a manner of loading the electrolytic catalyst on the cathode is to prepare the electrolytic catalyst into a dispersion and coat the dispersion on a bottom of the cathode.

2. The total recycle process of the carbonaceous components in the coal gas based on the integration of the CO₂ absorption and the electrocatalysis according to claim 1, wherein the coal gas comprises blast furnace coal gas or shaft furnace coal gas.

3. The total recycle process of the carbonaceous components in the coal gas based on the integration of the CO₂ absorption and the electrocatalysis according to claim 1, wherein the primary amine comprises a monoethanolamine and a 2-amino-2-methyl-1-propanol; and the secondary amine comprises a diethanolamine.

4. The total recycle process of the carbonaceous components in the coal gas based on the integration of the CO₂ absorption and the electrocatalysis according to claim 1, wherein a concentration of the primary amine and/or the secondary amine in the absorption solution with the primary amine and/or the secondary amine is 1 mole/liter (mol/L) to 5 mol/L.

5. The total recycle process of the carbonaceous components in the coal gas based on the integration of the CO₂ absorption and the electrocatalysis according to claim 1, wherein a temperature during the electrolysis is 10 degrees Celsius (°C) to 60°C, and an applied voltage is 0 volt (V) to -2 V versus (vs.) reversible hydrogen electrode (RHE).

6. The total recycle process of the carbonaceous components in the coal gas based on the integration of the CO₂ absorption and the electrocatalysis according to claim 1, wherein the CO/H₂ reducing gas is discharged above the cathode, mixed with the decarbonized coal gas, and returned to the smelting process for recycling.
